(19) United States
(12) Patent Application Publication
(10) Pub. No.: US 2024/0091780 A1
(43) Pub. Date: Mar. 21, 2024

(54) ANALYTE PERMEATION TESTING INSTRUMENT WITH TEST SAMPLE PERIPHERAL EDGE SEALING SURROUND

(71) Applicant: MOCON, INC, Minneapolis, MN (US)

(72) Inventors: Timothy A. Ascheman, Elk River, MN (US); Jeffrey L. Jackson, Lino Lakes, MN (US); Slava A. Berezovskiy, Apple Valley, MN (US)

(21) Appl. No.: 17/820,932

(22) Filed: Aug. 19, 2022

(51) Int. Cl. B01L 3/00; B01L 9/00; G01N 15/08

(52) U.S. Cl. CPC B01L 3/565; B01L 3/502; B01L 9/50; G01N 15/082; B01L 2200/0689; B01L 2200/141; B01L 2300/0663; G01N 2015/086

(57) ABSTRACT

An analyte permeation testing instrument with an edge leakage minimizing feature and a method of measuring permeability of a test film for a target analyte utilizing the analyte permeation testing instrument. The instrument includes a cartridge and a target analyte sensor. The cartridge has separable first and second plates having first and second cells respectively. The plates are operable for engaging a test film therebetween so as to sealingly separate the first and second cells. A surround around at least one of the first cell and the second cell projects within the interface between the first and second plates for engaging a periphery of the test film to compress the test film and thereby form a peripheral edge seal when the plates are clamped together.

### BACKGROUND

Permeation instruments are used to measure the transmission rate of a target analyte, such as oxygen, carbon dioxide or water vapor, through a film of interest. Typical films subjected to permeation testing are polymeric packaging films such as those constructed from low density polyethylene (LDPE), high density polyethylene (HDPE), oriented polypropylene (OPP), polyethylene terepthalate (PET), polyvinylidene chrloride (PVTDC), etc. Typically, the film to be tested is positioned within a test chamber to sealing separate the chamber into first and second cells. The first cell (commonly referenced as the sensing cell) is flushed with an inert gas to remove any target analyte from the cell and the second cell (commonly referenced as the analyte cell) filled with a gas containing a known concentration of the target analyte. A sensor for the target analyte detects the presence of target analyte that has migrated into the sensing cell from the analyte cell through the film.

Permeation instruments typically employ a flow-through method or an accumulation method for sensing the presence of target analyte in the sensing cell. Briefly, the flow-through method uses an inert flushing gas to continuously pick up any target analyte that has migrated into the sensing cell and deliver it to a remote sensor. The accumulation method allows target analyte to build up in the sensing cell for an accumulation period, with the sensor either positioned within the sensing cell or the sensing cell flushed with a flushing gas after the accumulation period for delivery of accumulated target analyte to a remote sensor.

The flow through method allows virtually all sensor types to be used, but are expensive and complex systems. The accumulation method, while permitting the use of less sensitive inexpensive sensors to accurately measure permeation of a target analyte through a film even at very low transmission rates, suffers from significantly longer test times.

Electrochemical sensors are generally preferred for use in permeation instruments as they provide a number of advantages, including (i) extreme accuracy, (ii) ultra-high sensitivity to analyte, (iii) high specificity for a single analyte, (iv) lack of temperature sensitivity, (v) lack of pressure sensitivity, (vi) minimal sensitivity to flow, and (vii) low cost.

Leakage of target analyte into the sensing cell other than via permeation across the test film from the analyte cell to the sensing cell can adversely affect accuracy of the test results. To maintain testing accuracy, such leakage must be eliminated as much as reasonably possible.

One area of concern regarding leakage of target analyte into the sensing cell is edge leakage, where environmental target analyte migrates into the test film through the exposed edges of the test film followed by permeation of the environmental target analyte into the analyte-depleted sensing cell. Edge leakage is of particular concern when the test film is rather thick so as to present a meaningful area of edge exposure to the surrounding environment.

Accordingly, a substantial need exists for a system and/or method for controlling and potentially eliminating edge leakage in permeation instruments.

### SUMMARY OF THE INVENTION

A first aspect of the invention is an analyte permeation testing instrument with an edge leakage minimizing feature. The analyte permeation testing instrument includes a cartridge and a target analyte sensor. The cartridge defines a testing chamber operable for engaging a test film such that the testing chamber is sealingly separated by the test film into a first cell and a second cell. Specifically, the cartridge includes at least (i) a first plate defining the first cell, (ii) a second plate defining the second cell, (iii) a clamping mechanism for releasable clamping engagement of the first and second plates for changing test films, and (iv) an edge leakage minimizing feature comprising a surround around at least one of the first cell and the second cell projecting within an interface between the first and second plates for engaging a periphery of the test film placed within the interface to compress the test film and thereby form a peripheral edge seal when the plates are clamped together. The target analyte sensor is in fluid communication with the second cell for sensing target analyte found within the second cell.

A second aspect of the invention is a method of measuring permeability of a test film for a given analyte utilizing the analyte permeation testing instrument according to the first aspect of the invention. The method includes the steps of (a) separating the first and second plates, (b) placing the test film over one of the cells, (c) clamping the first and second plates together to form the testing chamber, whereby (i) the first and second cells of the testing chamber are sealingly separated by the test film, and (ii) a periphery of the test film is compressed by the surround to form a peripheral edge seal, (d) introducing an analyte containing gas into the first cell, (e) flushing the second cell with an inert gas to deplete analyte in the second cell, and (f) periodically sensing analyte in the second cell with the analyte sensor.

### BRIEF DESCRIPTION OF THE DRAWINGS

FIG. 1 is a schematic overview of one embodiment of an analyte permeation testing system that includes the analyte permeation testing instrument of the present invention.

FIG. 2 is an exploded top perspective view of one embodiment of the cartridge and clamping components of the analyte permeation testing instrument of the present invention.

FIG. 3 is an orthographic projection of the exterior major surface of the first plate subcomponent of the cartridge with bolts inserted shown in FIG. 2.

FIG. 4 is an orthographic projection of the interior major surface of the first plate subcomponent of the cartridge shown in FIG. 2.

FIG. 5 is an orthographic projection of the exterior major surface of the second plate subcomponent of the cartridge shown in FIG. 2.

FIG. 6 is an orthographic projection of the interior major surface of the second plate subcomponent of the cartridge shown in FIG. 2.

FIG. 7 is a front view of the first and second plate subcomponents of the cartridge shown in FIG. 2 sans a depiction of the bolts, longitudinal bolt orifices, and flow channels through the plates for clarity.

FIG. 8 is a cross-sectional view of the of the cartridge shown in FIG. 2 in a clamped state including the test film, sans a depiction of the longitudinal bolt orifices and flow channels through the plate for clarity, and depicting a servomotor as an alternative mechanism for clamping the plates together.

FIG. 9 is an enlarged projection of that portion of the cartridge depicted in FIG. 9 encircled by circle A.

### DETAILED DESCRIPTION OF A PREFERRED EMBODIMENT

### Nomenclature

01 Source of Analyte Containing Test Gas
02 Source of Analyte Depleted Inert Gas
10 Analyte Permeation Testing System
21a Inlet Conduit for Directing Test Gas From the Source of Test Gas into the First Cell
21b Outlet Conduit for Venting Gas from the First Cell
22a Inlet Conduit for Directing Inert Gas From the Source of Inert Gas Into the Second Cell
22b₁ Outlet Conduit for Venting Inert Gas From the Second Cell
22b₂ Outlet Conduit for Directing Inert Gas From the Second Cell to the Target Analyte Sensor
30 Analyte Sensor
40 Computer or CPU
50 Monitor
60 Printer
70 Electrical Leads from the Sensor to the CPU
100 Cartridge
100a Front of Cartridge
100b Back of Cartridge
100c Top of Cartridge
100d Bottom of Cartridge
100r Right Side of Cartridge
100s Left Side of Cartridge
109 Testing Chamber
110 First Plate
110v Interior Major Surface of First Plate
110w Exterior Major Surface of First Plate
111 Inlet Port for Test Gas in Fluid Communication with First Cell
112 Outlet Port for Test Gas in Fluid Communication with First Cell
113 Longitudinally Extending Alignment Pins
119 First Cell in First Plate
120 Second Plate
120v Interior Major Surface of Second Plate
120w Exterior Major Surface of Second Plate
121 Inlet Port for Inert Gas in Fluid Communication with Second Cell
122 Outlet Port for Inert Gas in Fluid Communication with Second Cell
123 Longitudinally Extending Alignment Holes
129 Second Cell in Second Plate
130 Surround
131 Peripheral Lip Projecting from Interior Major Surface of First Plate
131e Exposed Edge of Peripheral Lip Projecting from the First Plate
132 Peripheral Lip Projecting from Interior Major Surface of Second Plate
132e Exposed Edge of Peripheral Lip Projecting from the Second Plate
200 Compression Sensor
300 Clamping Mechanism
310 Bolts
311 Longitudinal Orifices Through First Plate Circumscribing the Surround
312 Threaded Longitudinal Orifices Through Second Plate Circumscribing the Surround
320 Clamping Actuator
F Film Being Tested
x Lateral Direction
y Longitudinal Direction
z Transverse Direction

### Description

### Overview

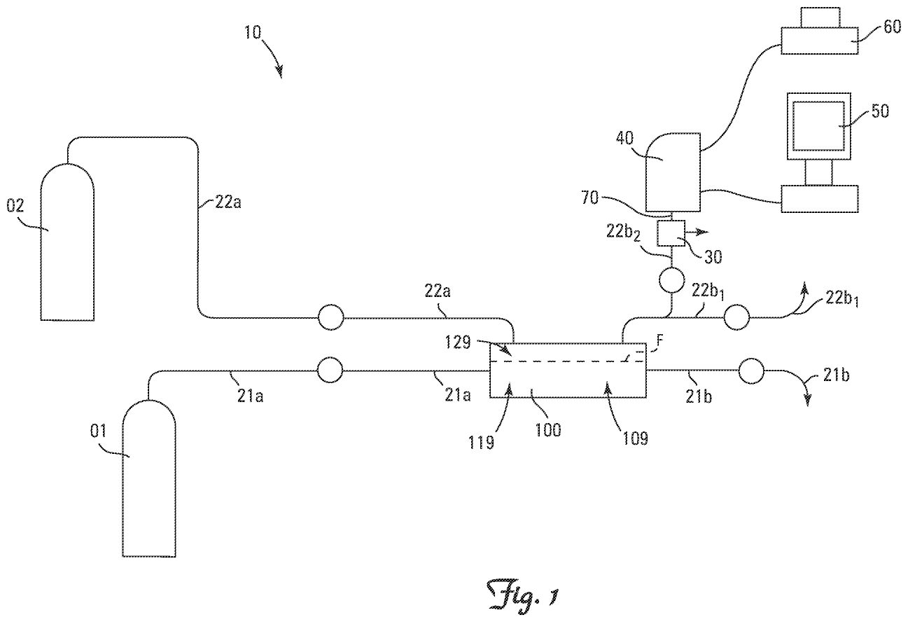

Referring generally to FIG. 1, the invention is directed to cartridge 100 as a component of an analyte permeation testing instrument 10. The analyte permeation testing instrument 10 includes at least a target analyte sensor 30 and the cartridge 100. The cartridge 100 is equipped with an edge leakage minimizing feature.

The cartridge 100 defines a testing chamber 109 operable for engaging a test film F such that the testing chamber 109 is sealingly separated by the test film F into a first cell 119 and a second cell 129. Specifically, the cartridge 100 can include at least (i) a first plate 110 defining the first cell 119, (ii) a second plate 120 defining the second cell 129, (iii) a clamping mechanism 320 for releasable clamping of the first and second plates 110 and 120 for changing test films F, and (iv) an edge leakage minimizing feature comprising a surround 130 around at least one of the first cell 119 and the second cell 129 projecting within an interface (unnumbered) between the first and second plates 110 and 120 for engaging a periphery of the test film F placed within the interface to compress the test film F and thereby form a peripheral edge seal (unnumbered) when the plates 110 and 120 are clamped together. The target analyte sensor 30 is in fluid communication with the second cell 129 for sensing target analyte which has permeated through the test film F from the first cell 119 into the second cell 129.

Construction

An exemplary embodiment of a system capable of measuring the transmission rate of a target analyte through a test film F utilizing the analyte permeation testing instrument 10 is depicted in FIG. 1. The cartridge 100 defines a testing chamber 109 sealingly divided by a film F to be tested into a first cell 119 and a second cell 129.

A source of test gas 01 containing a known concentration of a target analyte, communicates with the first cell 119 via inlet conduit 21a for continuously providing the first cell 119 with test gas to ensure that the concentration of target analyte within the first cell 119 remains constant throughout a test period. Test gas within the first cell 119 exits via outlet conduit 21b.

A source of an inert gas 02 communicates with the second cell 129 via inlet conduit 22a for flushing the first cell 119 prior to testing and then during testing carrying target analyte which has permeated through the test film F from the first cell 119 into the second cell 129 to the target analyte sensor 30. Inert gas within the second cell 129 exits via outlet conduit 22b, which splits for selectively and alternatively venting the inert gas directly to atmosphere through conduit 22b₁ during flushing of the second cell 129 prior to testing, or directing the inert gas through conduit 22b2 into target analyte sensor 30 for measurement of target analyte during testing. Suitable inert gases include specifically, but not exclusively, nitrogen, argon, helium, krypton, a blend of nitrogen and hydrogen, etc.

Channels (not shown) in the cartridge 100 and a flow control system (not separately numbered) are provided for directing and controlling the flow of test gas into and out from the first cell 119 and inert gas into and out from the second cell 129.

Shutoff valves (unnumbered) can be provided in inlet conduit 21a and outlet conduit 21b respectively, for controlling the flow of test gas through the first cell 119. Similarly, shutoff valves (unnumbered) can be provided in the inlet conduit 22a and outlet conduit 22b respectively for controlling the flow of inert gas through the second cell 129. A separate shutoff valve can be placed in each branch 22b₁ and 22b₂ of the outlet conduit 22 for selectively and alternatively directing flow of inert gas exiting the second cell 129 directly to atmosphere through conduit 22b₁ during flushing of the upper cell 129 prior to testing or through conduit 22b₂ into sensor 30 for measurement of target analyte during testing.

Referring to FIG. 1, the target analyte sensor 30 for sensing target analyte is placed in fluid communication with the second cell 129 for sensing the presence of target analyte within the second cell 129. Typical target analytes of interest include oxygen, carbon dioxide and water vapor. The target analyte sensor 30 may be selected from any of the wide variety of commercially available sensors capable of detecting the target analyte of interest, with electrochemical sensors generally preferred based upon the high sensitivity and low cost of such sensors and the fact that such sensors, when employed in the present invention, follow Faraday's Law—eliminating the need to calibrate the sensor.

The target analyte sensor 30 communicates via electrical leads 70 with a suitable central processing unit 40 equipped with electronic memory (not shown) for storing, and optionally but preferably a monitor 50 and/or printer 60 for reporting target analyte concentrations detected by the target analyte sensor 30.

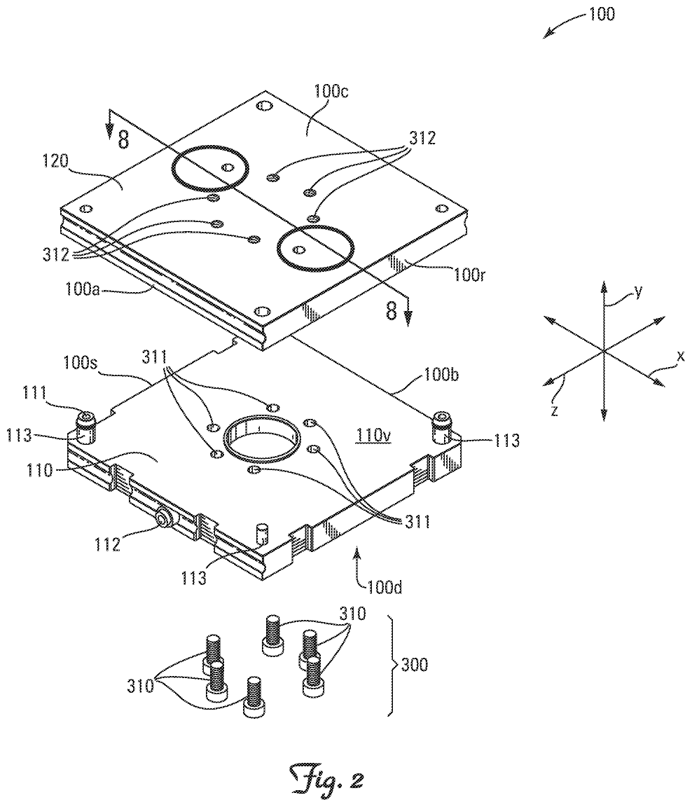

Referring generally to FIG. 2, the cartridge 100, formed from the first 110 and second 120 plates, has a lateral x width extending from a right side 100r to a left side 100s, a longitudinal y thickness extending from a top major surface 100c to a bottom major surface 100d, and a transverse z length extending from a front edge 100a to a back edge 100b.

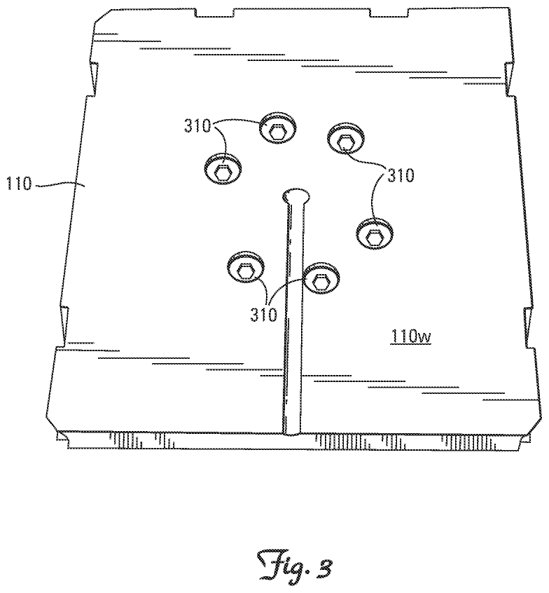

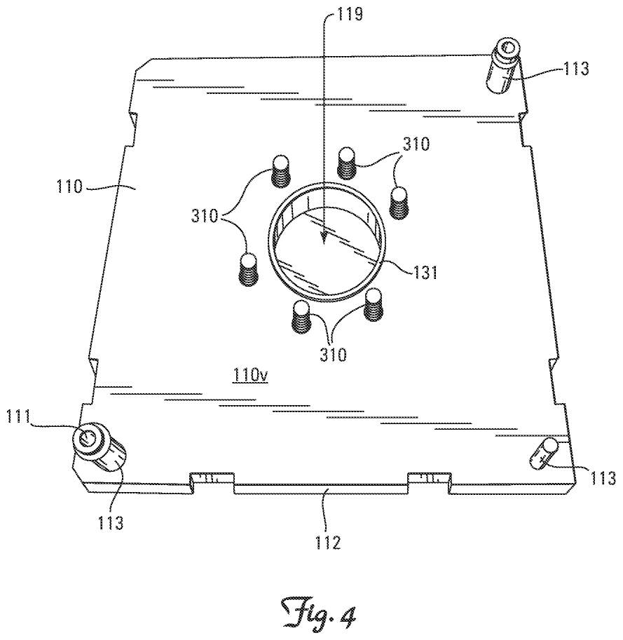

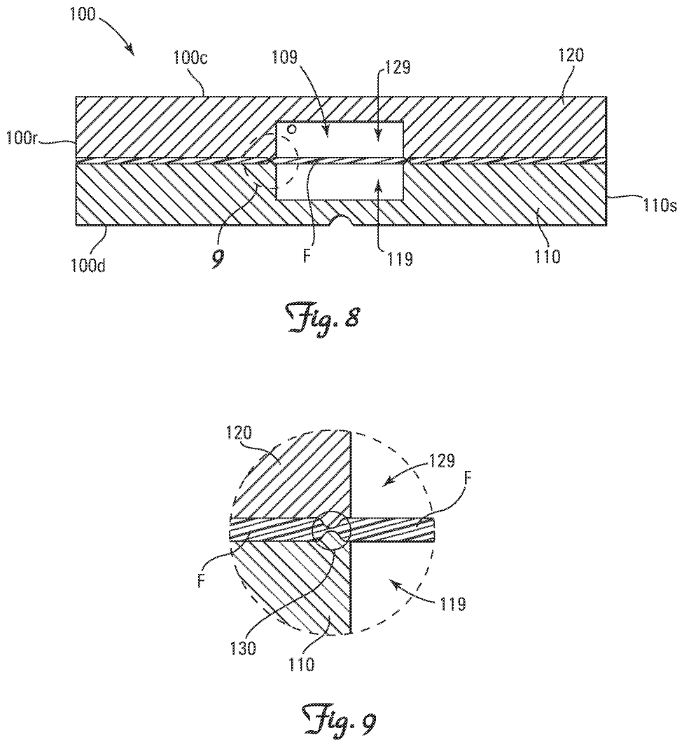

Referring generally to FIGS. 2, 3, 4, 7 and 8, the first plate 110 has an interior major surface 110v which faces the second plate 120 when the plates 110 and 120 are clamped together to form the cartridge 100, and an exterior major surface 110w which is the bottom major surface 100d of the cartridge 100 when the plates 110 and 120 are clamped together to form the cartridge 100.

Inlet and outlet ports 111 and 112 in the first plate 110 are configured and arranged for fluid connection to inlet conduit 21a and outlet conduit 21b respectively, for directing test gas into and out from the first cell 119.

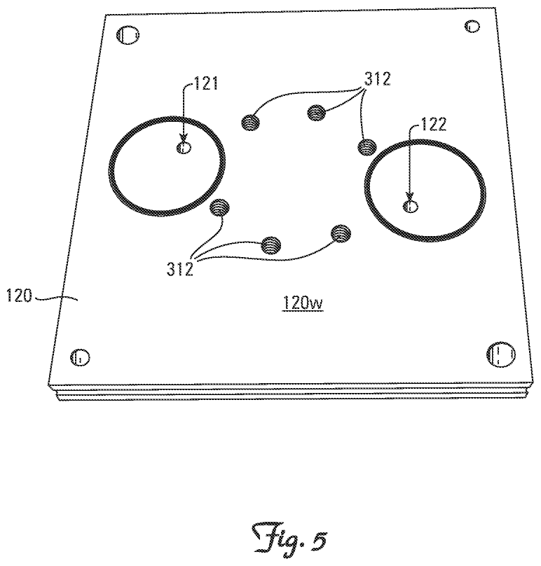

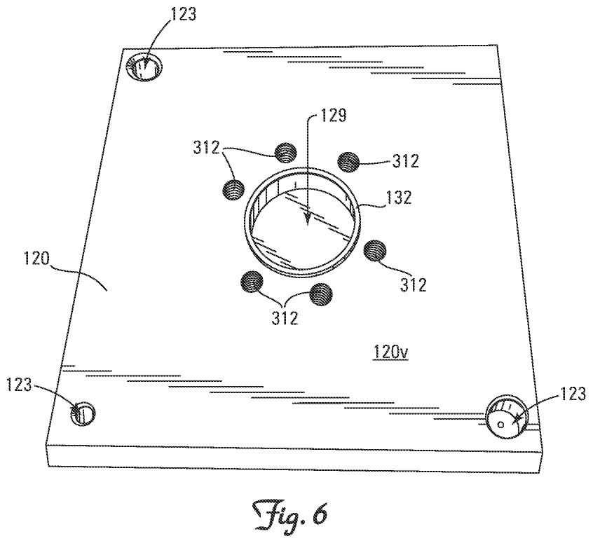

Referring generally to FIGS. 2, 5, 6, 7 and 8, in similar fashion the second plate 120 has an interior major surface 120v which faces the first plate 110 when the plates 110 and 120 are clamped together to form the cartridge 100, and an exterior major surface 120w which is the top major surface 100c of the cartridge 100 when the plates 110 and 120 are clamped together to form the cartridge 100.

Inlet and outlet ports 121 and 122 in the second plate 120 are configured and arranged for fluid connection to inlet conduit 22a and outlet conduit 22b respectively, for directing inert gas into and out from the second cell 129.

The first and second plates 110 and 120 each preferably comprise a unitary metal piece to eliminate cracks, seams, joints and fissures through the plate 110 or 120 and into fluid communication with the respective cells 119 and 129.

Referring generally to FIGS. 2, 4, 6 and 7, a set of alignment pins 113 extend longitudinally y out from the interior major surface 110v of the first plate 110 and corresponding alignment holes 123, configured and arranged to accept insertion of the alignment pins 113, extend longitudinally y into the second plate 120 from the interior major surface 120v of the second plate 120. The alignment pins 113 and alignment holes 123 ensure a proper and consistent alignment and rotational orientation of the plates 110 and 120 relative to one another. Alternatively, placement of the alignment pins 113 and alignment holes 123 on the first and second plates 110 and 120, can be reversed.

Referring generally to FIGS. 2, 4, 6, 7, 8 and 9, an edge leakage minimizing feature comprising a surround 130 is positioned within the interface between the first and second plates 110 and 120, for engaging and compressing a periphery of the test film F around the testing chamber 109 when the plates 110 and 120 are clamped together. Compression of the test film F around the testing chamber 109 forms a peripheral edge seal around the testing chamber 109 so as to control leakage of target analyte into the second cell 129 and thereby ensure that target analyte found within the second cell 129 permeated across the test film F from the first cell 119 to the second cell 129.

The surround 130 can be formed of a separate piece fitted into position between the first and second plates 110 and 120, or unitarily formed from a solid block of material with the first and/or second plate 110 and/or 120.

In a preferred embodiment, the surround 130 is a peripheral lip 131 projecting longitudinally y from the interior major surface 110v of the first plate 110 towards the interior major surface 120v of the second plate 120, or alternatively a peripheral lip 132 projecting longitudinally y from the interior major surface 120v of the second plate 120 towards the interior major surface 110v of the first plate 110. Most preferably, the surround 130 is comprised of peripheral lips 131 and 132 projecting longitudinally y from the interior major surfaces 110v and 120v of the first plate 110 and second plate 120, respectively, with the peripheral lips 131 and 132 aligned so that the exposed edges 131e and 132e of the peripheral lips 131 and 132, respectively, would contact and abut one another around the entire periphery of the testing chamber 109 when the plates 110 and 120 are clamped together without an inserted testing film F. The exposed edges 131e and 132e of the peripheral lips 131 and 132 are preferably rounded to provide a radially narrow peripheral line of contact.

Any of the well known and readily available compressing and clamping devices may be used as the clamping mechanism 300 to clamp the plates 110 and 120 together, including specifically but not exclusively manually-operated lever and rotary mechanical actuators such as a plurality of bolts 310 and bolt holes 311 (pass through) and 312 (threaded) through the plates 110 and 120 respectively, circumscribing the first and second cells 119 and 129 respectively, electromechanical actuators such as a servomotor 320, pneumatic actuators, and hydraulic actuators.

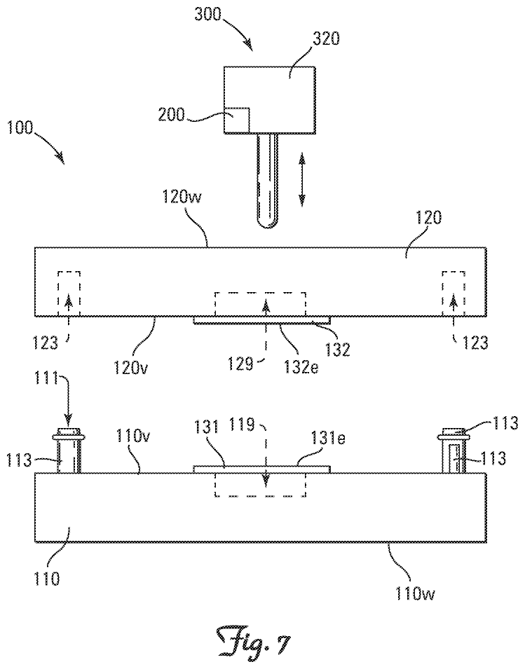

Referring generally to FIG. 7, a compression sensor 200 can be employed to sense and report the clamping pressure and/or force exerted upon and/or experience by the plates 110 and 120, and reporting the value to the controller 40 for maintaining a consistent compression pressure and/or force for each test film F.

Use

The first and second plates 110 and 120 are separated and a sample of film F to be tested placed over the first cell 109 in the first plate 110 so as to circumferentially extend over the entire periphery of the peripheral lip 131 encircling the first cell 109.

The second plate 120 is then placed back atop the first plate 110 and secured to the first plate 110 so as to sealingly clamp the film F between the peripheral lips 131 and 132 on the plates 110 and 120 respectively, thereby compressing the film F between the peripheral lips 131 and 132 so as to create an edge seal and sealingly separate the first cell 119 and second cell 129 from one another as well as the surrounding environment, with a known area of the film F exposed to both cells 119 and 129, hereinafter referenced as a “loaded” cartridge 100.

Shutoff valves (unnumbered) along conduits 22a and 22b₁ are then opened to permit the flow of inert gas from the source of analyte depleted inert gas 02 through the second cell 129 and out to the surrounding environment for flushing analyte from the second cell 129. After flushing, shutoff valve along conduit 22b₁ is closed and shutoff valve along conduit 22b2 is open to direct gas flow from the second cell 129 through the analyte sensor 30. The presence of analyte within the second cell 129 is thereby detected and recorded.

Shutoff valves (unnumbered) along conduits 21a and 21b are then opened to permit the flow of gas from the source of gas containing a known concentration of analyte 01 into the first cell 119.

Target analyte will permeate through the film F as the analyte seeks to diffuse through the film F from a region of higher concentration (i.e., the first cell 119) to a region of lower concentration (i.e., the second cell 129). Since test gas continuously flows through the first cell 119 the concentration of target analyte in the region of higher concentration remains constant throughout the relevant test period. Similarly, since inert gas continuously flows through the second cell 129 for carrying a target analyte within the second cell 129 to the analyte sensor 30, the concentration of target analyte in the region of lower concentration also remains constant at near zero throughout the relevant test period.

Eventually, the system will reach a steady state condition where the rate at which analyte is detected in the second cell 129 by the analyte sensor 30 and reported by the central processing unit 40 remains constant. By ensuring that the only route by which analyte can enter into the second cell 129 is through the “exposed” area of the film F, this steady state rate equates directly to the permeation rate for the film F for the “exposed” area of the film F.

I claim:

1. An analyte permeation testing instrument, comprising:
(a) a cartridge defining a testing chamber operable for engaging a test film such that the testing chamber is sealingly separated by the test film into a first cell and a second cell, the cartridge including at least:
(1) a first plate defining the first cell,
(2) a second plate defining the second cell,
(3) a clamping mechanism for releasable clamping engagement of the first and second plates for changing test films, and
(4) a surround around at least one of the first cell and the second cell projecting within an interface between the first and second plates for engaging a periphery of the test film placed within the interface to compress the test film and thereby form a peripheral edge seal when the plates are clamped together, and
(b) a sensor for sensing a target analyte in fluid communication with the second cell.

2. The analyte permeation testing instrument of claim 1 wherein (i) the first and second cells are spaced in a longitudinal direction, and (ii) the surround is comprised of a pair of longitudinally aligned and longitudinally raised peripheral lips with one lip of the pair of lips projecting from each of the first and second plates.

3. The analyte permeation testing instrument of claim 2 wherein the peripheral lips each have a rounded longitudinal facing exposed edge.

4. The analyte permeation testing instrument of claim 2 wherein the first plate and associated peripheral lip are unitarily formed from a solid block of metal.

5. The analyte permeation testing instrument of claim 4 wherein the second plate and associated peripheral lip are unitarily formed from a solid block of metal.

6. The analyte permeation testing instrument of claim 1 wherein the clamping mechanism is a plurality bolts slidably engaged through orifices in one of the first and second plates and threadably engaged within corresponding orifices in the other of the first and second plates, the orifices circumscribing the surround.

7. The analyte permeation testing instrument of claim 1 wherein the clamping mechanism is an electromechanical actuator operable for pressing one of the first or second plate against the other first or second plate.

8. The analyte permeation testing instrument of claim 7 further comprising a compression sensor and control unit for sensing and controlling the compression force of the one plate against the other plate.

9. The analyte permeation testing instrument of claim 1 wherein the sensor is an oxygen sensor.

10. The analyte permeation testing instrument of claim 1 wherein the sensor is a carbon dioxide sensor.

11. The analyte permeation testing instrument of claim 1 wherein the sensor is a water vapor sensor.

12. A method of measuring permeability of a test film for a given analyte utilizing the analyte permeation testing instrument of claim 1, comprising:
(a) separating the first and second plates,
(b) placing the test film over one of the cells,
(c) clamping the first and second plates together to form the testing chamber, whereby (i) the first and second cells of the testing chamber are sealingly separated by the test film, and (ii) a periphery of the test film is compressed by the surround to form a peripheral edge seal,
(d) introducing an analyte containing gas into the first cell,
(e) flushing the second cell with an inert gas to deplete analyte in the second cell, and
(f) periodically sensing analyte in the second cell with the analyte sensor.
